(19) United States
(12) Patent Application Publication
(10) Pub. No.: US 2006/0077874 A1
(43) Pub. Date: Apr. 13, 2006

(54) Recording medium

(75) Inventor: Shiro Morotomi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/211,457

(22) Filed: Aug. 26, 2005

(30) Foreign Application Priority Data
Sep. 22, 2004 (JP) 2004-275472

(51) Int. Cl. G11B 7/24

(52) U.S. Cl. 369/275.1

(57) ABSTRACT

On a recording medium on which information is recorded in the form of data signals, class information representing a class regarding the information recorded in the form of the data signals is recorded at least visually. For example, on a recording medium on which pieces of data encoded according to a plurality of encoding schemes can be recorded, a recommended encoding scheme is visually presented.

### CROSS REFERENCES TO RELATED APPLICATIONS

The present invention contains subject matter related to Japanese Patent Application JP 2004-275472 filed in the Japanese Patent Office on Sep. 22, 2004, the entire contents of which are incorporated herein by reference.

### BACKGROUND OF THE INVENTION

1. Field of the Invention

The present invention relates to a recording medium on which information is recorded in the form of data signals.

2. Description of the Related Art

Various types of codec have hitherto been proposed to code content data for recording on recording media, so that maximum recording time is increasing and quality of playback data is improving.

Under the current situation where various types of codec exist, for example, a situation can occur where pieces of content data are recorded using different codecs on recording media of the same media type. For example, a piece of content data coded based on linear PCM (pulse code modulation) and a piece of content data coded based on MP3 (MPEG Audio Layer-3) are recorded on a CD-R (compact disc recordable), or a piece of content data coded based on linear PCM and a piece of content data coded based on ATRAC3 (Adaptive TRansform Acoustic Coding 3) are recorded on an MD (mini disc, which is a type of magneto-optical disc).

In this case, a recording apparatus used is configured so that a user can select a desired codec for recording content data. Thus, for example, the user can record content data of a longer period on a recording medium having the same capacity by selecting a codec with a higher compression ratio. Alternatively, the user can record content data at a higher quality by selecting a codec with a lower compression ratio.

When pieces of content data are recorded using different codecs on recording media of the same media type as described above, a playback apparatus compatible with the media has to properly recognize codec information of the content data in order to play back the data.

Thus, in recording media that have been used, pieces of codec information are stored in association with pieces of content data in management information as described, for example, in Japanese Unexamined Patent Application Publication No. 2002-208246, so that the playback apparatus can refer to information of a codec that is to be used for playback of the content data.

### SUMMARY OF THE INVENTION

Although the above description has been given in the context of a case where the recording media used are writable discs, also in the case of read-only discs (package media), it is possible to record content data on media of the same type using different codecs.

For example, with package media of the same media type, content of a longer period is recorded on one medium using a codec with a high compression ratio, while the quality of playback signals of content is enhanced on another medium using a codec with a low compression ratio.

This indicates that the qualities of content data recorded on package media can vary even when the package media are of the same media type.

As an example of package media currently used, in audio CDs, the same type of codec is used so that content data that is recorded has a uniform quality. Considering this situation, the situation where the qualities of data recorded on package media of the same media type can vary could cause confusion for users.

It is desired that a recording medium having the following characteristics be provided.

According to an embodiment of the present invention, a recording medium on which information is recorded in the form of data signals is provided. On the recording medium, class information representing a class regarding the information recorded in the form of the data signals is recorded at least visually.

By recording class information at least visually as described above, the class information can be presented visually to a user.

Furthermore, for example, when information representing a class of playback signal quality of content data recorded on the recording medium is recorded as the class information, the user can recognize in advance the quality of content data recorded on the recording medium.

As described above, class information regarding information recorded on the recording medium in the form of data signals is recorded at least visually, so that the class information can be presented in advance to a user.

Furthermore, when information representing a class of playback signal quality of content data recorded on the recording medium is recorded as the class information, even when pieces of content data having different playback signal qualities are recorded on media of the same media type, confusion by the user.

### BRIEF DESCRIPTION OF THE DRAWINGS

FIG. 1 is an external view of a recording medium according to an embodiment of the present invention, which mainly serves to explain the structure thereof;

FIG. 2 is a diagram showing association between classes of codecs for recording content data on a recording medium and quality classes thereof and whether simultaneous recording is performed;

FIGS. 3A and 3B are external views of recording media according to the embodiment, showing examples of class information visually recorded;

FIG. 4 is a diagram showing the data structure of class information recorded in the form of data signals;

FIG. 5 is a diagram showing association between values of class information and quality classes/whether simultaneous recording is performed;

FIG. 6 is a diagram showing association between values of class information and codec classes;

FIG. 7 is a diagram showing the data structure of class information recorded in the form of data signals in a modification of the embodiment; and

FIG. 8 is a diagram showing association between values of class information and quality classes in the modification.

### DESCRIPTION OF THE PREFERRED EMBODIMENTS

Now, embodiments of the present invention will be described.

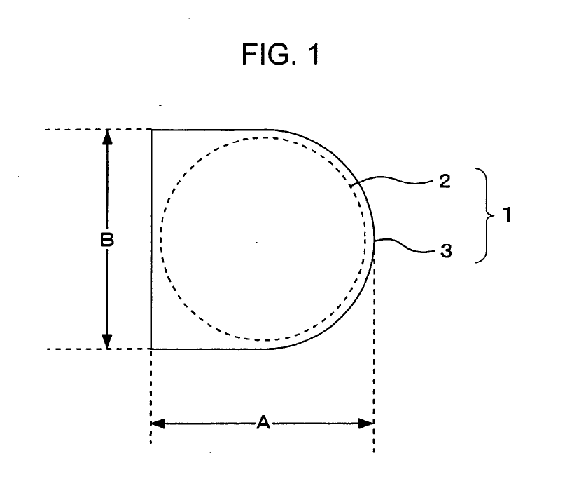

FIG. 1 is an external view of a recording medium 1 according to an embodiment of the present invention.

In the recording medium 1, a cartridge 3 contains a disc 2 as shown in FIG. 1.

The disc 2 is a read-only disc on which data signals are recorded in the form of embossed pits. The diameter of the disc 2 is approximately 60 mm as shown in FIG. 1. For example, the disc 2 has a data storage capacity of approximately 1.8 GB (gigabytes) by double-layer recording.

The cartridge 3 has such a shape that one half thereof as viewed in plan is semicircular along the arc of the disc 2 contained therein, and the other half thereof is substantially rectangular with two corners, as shown in FIG. 1.

The size of the cartridge 3, i.e. the outer dimension of the recording medium 1, is such that the length A in the convex direction of the semicircular region is approximately 65 mm, and the length B in the direction perpendicular to the convex direction of the semicircular region is approximately 64 mm.

In the recording medium 1, audio content data can be recorded on the disc 2.

The content data can be recorded, for example, by the following codecs according to specifications:
ATRAC (Adaptive TRansform Acoustic Coding) 3plus (1.4 Mbps)
ATRAC3plus (256 kbps)
ATRAC3plus (64 kbps)
Linear PCM (pulse code modulation)

In this specification, codecs are classified on the basis of coding algorithms used for recording.

ATRAC3plus (1.4 Mbps) is a provisional name, and it is described simply as an example of codec that provides the highest quality among ATRAC3plus codecs.

In this embodiment, for the plurality of codecs that can be used for recording, classes corresponding to respective playback signal qualities in accordance with playback rates (compression ratios) are defined.

That is, quality classes for respective playback signal qualities of pieces of content data recorded on the disc 2 are defined.

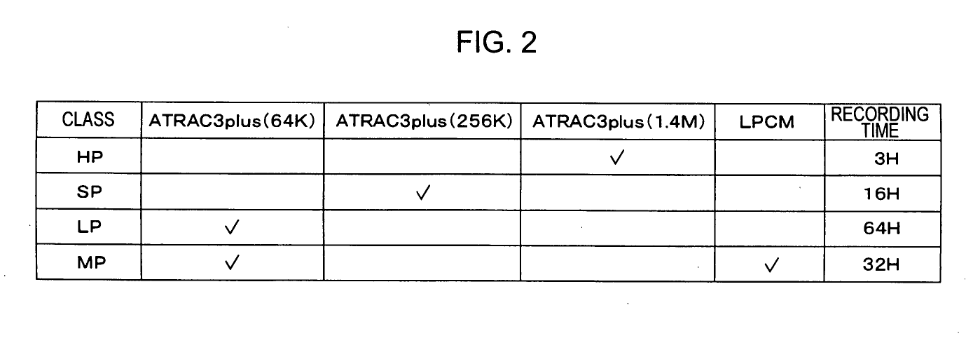

FIG. 2 shows the association between the quality classes and playback signal qualities.

Referring to FIG. 2, in this example, “HP”, “SP”, and “LP” are defined as quality classes.

That is, of the codecs based on ATRAC3plus listed above, when content data is recorded on the recording medium 1 using the ATRAC3plus (1.4 Mbps) codec, whose compression ratio is lowest and which provides the highest audio quality, the quality class “HP” applies.

When content data is recorded on the recording medium 1 using the ATRAC3plus (256 kbps) codec, whose compression ratio is next lowest and which allows a longer period of recording but provides somewhat degraded audio quality, the quality class “SP” applies.

When content data is recorded on the recording medium 1 by the ATRAC3plus (64 kbps) codec, whose compression ratio is highest and which allows a longest period of recording but provides the lowest audio quality, the quality class “LP” applies.

In this case, as well as recording all the content data on the disc 2 by a single type of codec, it is also possible to simultaneously record a plurality of pieces of content data yielded by coding the same content data by different codecs (which is referred to as simultaneous recording).

In this example, the same content data is recorded by simultaneous recording based on linear PCM and ATRAC3plus (64 kbps). When simultaneous recording is performed on the recording medium 1, the quality class “MP” applies.

In comparison with the quality class “MP”, the quality classes “HP”, “SP”, and “LP” serve as information representing recording media on which simultaneous recording is not performed. That is, in this case, whether simultaneous recording is performed is represented by the distinction of “MP” from “HP”, “SP”, and “LP”.

The types of codecs used for simultaneous recording of content data may be other combinations, such as a combination of ATRAC3plus (1.4 Mbps) and ATRAC3plus (64 kbps).

However, regardless of the types of codecs used, when simultaneous recording is performed on the recording medium 1, the quality class “MP” applies.

In this example, the maximum recording period of content data on the recording medium 1 according to the quality classes described above is on the order of three hours for “HP”, on the order of 16 hours for “SP”, and on the order of 64 hours for “LP”, as shown in FIG. 2. In the case of “MP” according to the example combination described above, the maximum recording period is on the order of 32 hours.

In this embodiment, with the classes defined as described above, class information representing a class is visually recorded on the outer surface of the cartridge 3.

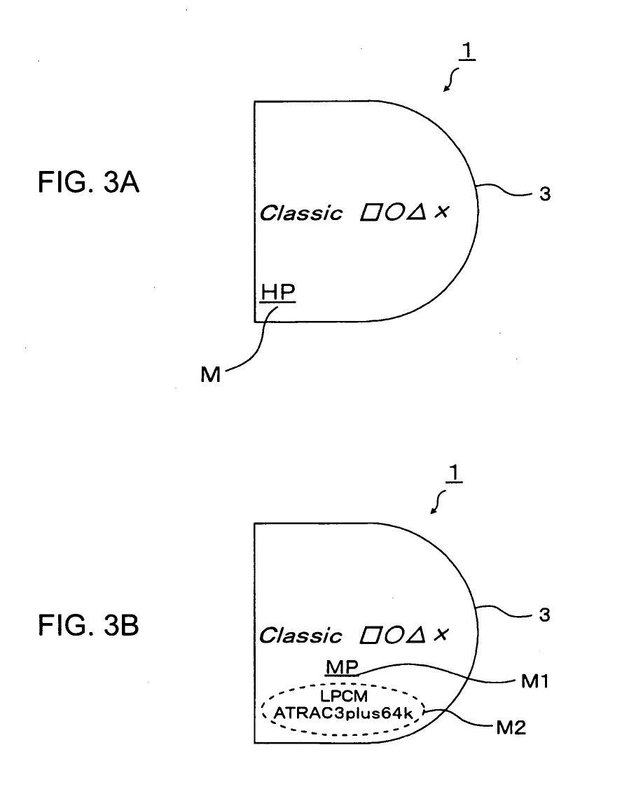

That is, as indicated by “M” in FIG. 3A, class information representing the class “HP”, “SP”, “LP”, or “MP” to which the recording medium 1 belongs is visually recorded at a specific position on the outer surface of the cartridge 3.

On the outer surface of the cartridge 3, information other than class information, such as title information of content data recorded on the recording medium 1, may also be visually recorded, as shown in FIG. 3A.

Furthermore, in addition to the class information representing “HP”, “SP”, “LP”, or “MP”, information representing the types of codecs may be recorded, as shown in FIG. 3B.

For example, referring to FIG. 3B, information representing the class to which the recording medium 1 belongs is recorded at a specific position as indicated by “M1”, and information representing the types of codecs is recorded at a specific position as indicated by “M2”.

In the example shown in FIG. 3B, the recording medium 1 belongs to the class “MP”. For example, when the combination of linear PCM and ATRAC3plus (64 K) is used, information representing these codecs, such as “LPCM” and “ATRAC3plus64k”, is presented as shown.

Alternatively, in the case of the quality class “MP”, of a plurality of codecs used for simultaneous recording, information representing only the codec that provides the highest audio quality may be presented.

As described above, on the recording medium 1, class information regarding at least playback signal quality of content data recorded on the disc 2 is visually recorded. Thus, the user can immediately recognize the class of audio quality of the content data recorded on the disc 2.

Accordingly, even when content data is recorded with different audio qualities on package media (read-only media) of the same media type, users can recognize the audio qualities before purchasing the package media. This serves to effectively prevent confusion of users as to the difference in audio quality among the media.

Furthermore, by defining the class “MP”, the class “MP” can be presented to the user when simultaneous recording is performed on the recording medium 1.

Furthermore, by visually recording information representing a codec type as shown in FIG. 3B, the type of a codec used for recording content data on the recording medium 1 can be presented to the user.

Furthermore, in this embodiment, in addition to recording class information visually as described above, the class information is also recorded on the disc 2 in the form of data signals so that an apparatus that plays back data from the recording medium 1 can read the data signals.

More specifically, the class information is recorded in management information regarding content data recorded on the disc 2.

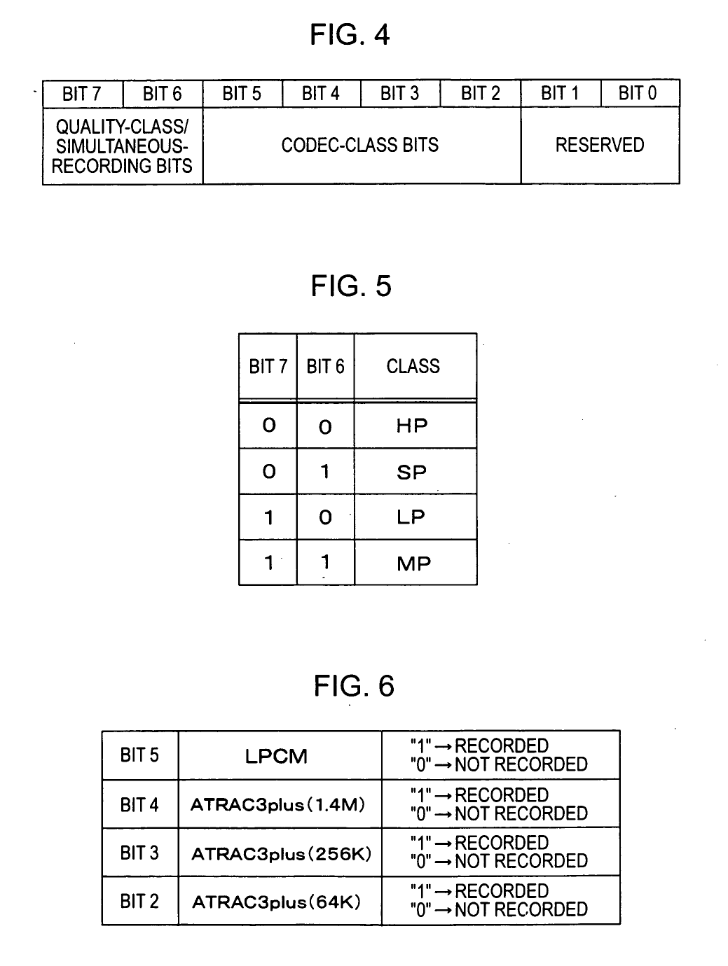

The class information is configured, for example, as shown in FIG. 4.

Referring to FIG. 4, in this example, the class information is composed of 8 bits including bit 7 to bit 0.

Of the 8 bits, bit 7 and bit 6 are quality class/simultaneous recording bits. That is, these two bits represent one of the classes (HP, SP, LP, and MP) described with reference to FIG. 2.

The 4 bits from bit 5 to bit 2 are codec-class bits. That is, these bits represent codec-class information representing the type of a codec used for recording content data on the disc 2.

The remaining 2 bits, i.e., bit 1 and bit 0, are reserved.

FIG. 5 shows association between the respective classes and the values of the quality class/simultaneous recording bits represented by bit 7 and bit 6.

As shown in FIG. 5, in this example, when the values of bit 7 and bit 6 are “00”, the quality class “HP” is represented. Similarly, the values “01” represent the quality class “SP”, and the values “10” represent the quality class “LP”. The values “11” represent “MP” indicating simultaneous recording.

FIG. 6 shows an example of association between codec types and the values of the codec-class bits represented by bit 5 to bit 2.

In this example, the codec class is represented by the position of “1” among bit 5 to bit 2.

That is, when the value of bit 5 is “1”, content data recorded is generated by a linear PCM codec.

When the value of bit 4 is “1”, content data recorded is generated by an ATRAC3plus (1.4 Mbps) codec.

When the value of bit 3 is “1”, an ATRAC3plus (256 kbps) codec is used. When the value of bit 2 is “1”, an ATRAC3plus (64 kbps) codec is used.

When the value of each of these bits is “0”, it is indicated that content data generated by the relevant type of codec is not recorded.

With the setting of these codec-class bits, for example, when the values of bits 5 to 2 are “0100”, it is indicated that only content data generated by the ATRAC3plus (1.4 Mbps) codec is recorded. Accordingly, the values of bit 7 and bit 6 described earlier should be “00” in accordance with the class “HP”.

As another example, when the values of bit 5 to bit 2 are “1001”, it is indicated that pieces of content data generated by two codecs, namely, the linear PCM codec and the ATRAC3plus (64 kbps) codec, are recorded. That is, the values of bit 7 and bit 6 should be “11” for the class “MP” indicating simultaneous recording.

When the class information is also recorded in the form of data signals on the recording medium 1 as described above, an apparatus that plays back data from the recording medium 1 displays the quality-class information of content data recorded on the disc 2 (and information indicating whether simultaneous recording is performed).

Thus, the class information visually recorded on the recording medium 1 is also presented on the display of the apparatus, so that the user can reconfirm the class information.

Furthermore, by recording codec-class information representing a codec type, an apparatus used for playback can reliably recognize a codec that is to be used for playing back content data recorded on the disc 2 and play back the content data.

When one quality class includes two or more codec types, for example, because a large number of codecs can be used for recording, or when simultaneous recording is performed as described earlier, it is not possible to determine by a playback apparatus which codec is to be used for playback if the class information includes only a quality class and a class as to whether simultaneous recording is performed. However, by separately recording codec-class information, it is possible to reliably recognize a codec that is to be used for playing back content.

Next, a modification of the embodiment will be described.

In this modification, the class “MP” indicating whether simultaneous recording is performed is omitted, and the distinction among “HP”, “SP”, and “LP” is simply used as a quality class.

When simultaneous recording is performed on the recording medium 1, of a plurality of codecs, a codec that provides the highest audio quality is visually recorded. For example, when pieces of content data yielded by the ATRAC3plus (256 k) codec and the ATRAC3plus (64 k) codec are recorded by simultaneous recording, “HP”, representing the quality class to which the ATRAC3plus (256 k) codec that provides the highest quality belongs, is visually recorded.

Also in this case, a class representing the codec type may be visually recorded as well as the quality class.

In accordance with the modification described above, class information recorded on the recording medium 1 in the form of data signals is also modified.

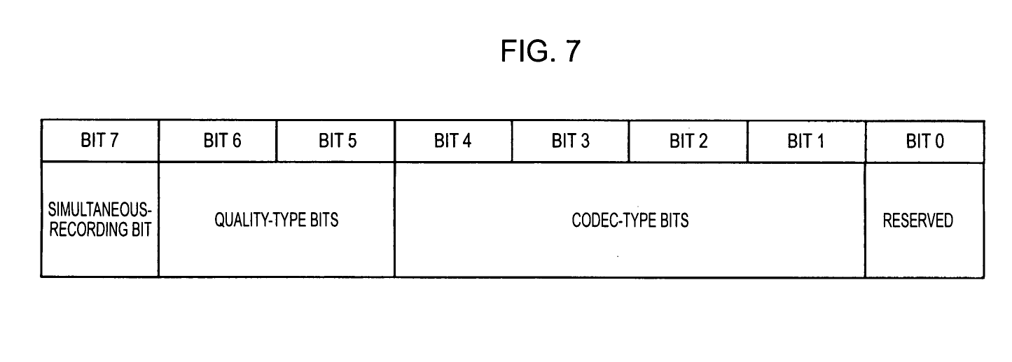

FIG. 7 shows an example of class information in this case.

As shown in FIG. 7, also in this case, class information recorded in the form of data-signals is composed of, for example, 8 bits. In this case, as opposed to the case shown in FIG. 4, bit 7 is used as a simultaneous recording bit. That is, whether simultaneous recording is performed on the recording medium 1 can be determined based on whether the value of bit 7 is “0” or “1”.

Bit 6 and bit 5 are used as quality-class bits representing a quality class.

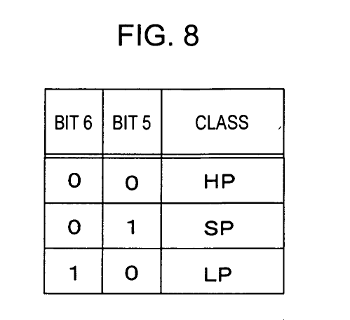

For example, as shown in FIG. 8, the quality class is “HP” when the values of bit 6 and bit 5 are both “0”, the quality class is “SP” when the values of bit 6 and bit 5 are “0” and “1”, and the quality class is “LP” when the values of bit 6 and bit 5 are “1” and “0”.

Bit 4 to bit 1 are used as codec-class bits. That is, bit 4 to bit 1 serve as information representing the type of a codec used for recording content on the recording medium 1, similarly to the case shown in FIG. 6.

In this case, only bit 0 is reserved.

Based on such class information, an apparatus that plays back data from the recording medium 1 can determine whether simultaneous recording is performed based on the simultaneous recording bit. Furthermore, the apparatus can correctly recognize each codec used for recording content data on the recording medium 1 even when simultaneous recording is performed.

Furthermore, using the quality-class bits based on the association shown in FIG. 8, the playback apparatus can display class information based on only the quality class representing distinction among “HP”, “SP”, and “LP”.

Obviously, also in this case, the playback apparatus can display information representing the codec type based on the values of the codec-class bits.

Although the embodiment has been described in the context of an example where the recording medium 1 (the disc 2) is a read-only (ROM) disc, this embodiment can be applied to a case where the recording medium 1 (the disc 2) is a writable disc.

In this case, however, the usage of class information differs from that in the case of a read-only disc.

More specifically, an apparatus that performs recording on the writable disc, upon obtaining information of the codec-class bits recorded in the form of data signals, automatically selects a codec that is to be used for recording content data, and records the content data using the codec.

Assuming that the recording apparatus operates as described above, in this case, the user can recognize, based on the class information visually recorded on the recording medium 1, for example, at the time of purchase, that content data can be recorded by a codec in accordance with the class information. That is, the user can readily recognize the expected audio quality and maximum recording time.

Actually, by the operation of the recording apparatus described above, a codec in accordance with the class information visually recorded is automatically selected, and recording on the recording medium 1 is performed using the codec.

That is, the user simply purchases the recording medium 1 on which desired class information is visually recorded, loads the recording medium 1 on a recording apparatus, and performs an operation for recording content data, whereby content data is automatically recorded by an intended codec. That is, it is possible to record content data by an intended codec without operations for selecting or setting the codec.

Thus, even a user who is not familiar with operations of an apparatus can readily record content data by an intended codec.

Furthermore, although the embodiment has been described in the context of an example where the class information represents a class of playback signal quality of content data and a class of codec, other class information may be used.

For example, specification that allows image data, such as special images of jackets or artists, to be attached to audio content data will be assumed.

Package media of such specification can be classified into package media on which only audio data is recorded and package media on which both audio data and image data are recorded.

The user can select a package medium to purchase based on the presence or absence of such attached images.

Thus, in this case, class information regarding the presence or absence of such attached data may be recorded on the recording medium. That is, information representing the presence or absence of such attached data is recorded at least visually.

Thus, the user can recognize in advance the presence or absence of attached data. Accordingly, confusion of users due to the presence or absence of attached data among package media of the same type can be avoided.

Furthermore, although the embodiment has been described in the context of an example where audio data is recorded on a recording medium, this embodiment can also be applied to a case where video data is recorded.

Furthermore, although the embodiment has been described in the context of an example where a cartridge-type recording medium is used, this embodiment can also be applied to a case where a bare disc is used as a recording medium.

When a bare disc is used, for example, class information is visually recorded at a specific position on a label surface.

Furthermore, this embodiment can also be applied to cases where media other than disc media are used.

For example, this embodiment can be applied to a semiconductor-memory recording medium. Also in this case, class information is visually recorded at a specific position on the outer surface of the casing.

It is to be understood that the names “HP”, “SP”, and “LP” representing audio-quality classes are only examples, and other names may be used. Also, instead of “MP” representing simultaneous recording, other names may be used.

Furthermore, the association between audio-quality classes and codecs is only an example, and other associations may be used.

It should be understood by those skilled in the art that various modifications, combinations, sub-combinations and alterations may occur depending on design requirements and other factors insofar as they are within the scope of the appended claims or the equivalents thereof.

What is claimed is:

1. A recording medium on which information is recorded in the form of data signals,
wherein class information representing a class regarding the information recorded in the form of the data signals is recorded at least visually.

2. The recording medium according to claim 1,
wherein the recording medium is a read-only recording medium.

3. The recording medium according to claim 1,
wherein the class information represents a class of playback signal quality of content data recorded in the form of the data signals.

4. The recording medium according to claim 1,
wherein the class information represents a class of a codec used to code content data recorded in the form of the data signals.

5. The recording medium according to claim 1,
wherein the class information represents a class regarding whether pieces of content data coded by different codecs are mixed as content data recorded in the form of the data signals.

6. The recording medium according to claim 1,
wherein the class information is also recorded in the form of data signals as management information regarding content data recorded in the form of the data signals.

7. The recording medium according to claim 6,
wherein the class information recorded as the management information includes quality-class information representing a class of playback signal quality of the content data and codec-class information representing a class of a codec used to code the content data.

8. The recording medium according to claim 6,
wherein the class information recorded as the management information includes information representing a class regarding whether pieces of content data coded by different codecs are mixed as content data recorded in the form of the data signals.
